(19) United States
(12) Patent Application Publication
(10) Pub. No.: US 2012/0036513 A1
(43) Pub. Date: Feb. 9, 2012

(54) METHOD TO ASSIGN TRAFFIC PRIORITY OR BANDWIDTH FOR APPLICATION AT THE END USERS-DEVICE

(76) Inventor: Khong Neng Choong, Kuala Lumpur (MY)

(21) Appl. No.: 13/122,050

(22) PCT Filed: Sep. 25, 2009
(86) PCT No.: PCT/MY2009/000161

§ 371 Date: Oct. 25, 2011

(30) Foreign Application Priority Data
Oct. 3, 2008 (MY) PI 20083931

(51) Int. Cl. G06F 9/46

(52) U.S. Cl. 718/104

(57) ABSTRACT

A resource reservation method in a network, where the allocation of network bandwidth to each application connected to the network is determined by the end user is provided herewith.

### FIELD OF INVENTION

The present invention relates to the area of resource reservation control mechanisms in a network. More specifically, the present invention relates to a method of customizing the Quality of Service (QoS) according to a user's specific need.

### BACKGROUND OF INVENTION

Communication networks transports numerous applications and data, including high-quality video and delay-sensitive data such as real-time voice, which stretches the network capabilities and resources. Networks are expected to provide secure, predictable, measurable and somewhat guaranteed services. To achieve this QoS policies are established by the network operator to provide guarantees on the ability of a network to deliver predictable results.

QoS can be applied to prioritize traffic for latency-sensitive applications (such as voice over video) and to control the impact of latency-insensitive traffic (such as bulk data transfer). In other words, QoS is a technique to manage network resources which manages the elements of delay, delay variation (jitter), bandwidth and packet loss parameters.

QoS policies are drawn by the network operator to which the end users agrees when they subscribe to the network. QoS policies are defined according to the traffic/packet classes such as real-time and non-real time without considering the specific applications needs. Therefore, it is quite common to have real time traffic such as audio and video being given priority for delivery as compare to non-real time traffic such as file downloading and browsing.

However, this may not suit the expectations or the requirement of each end users especially those who are not concerned with real time traffic. The preferred applications of this type of users for example file download is likely to be given the lowest priority due to the network operator defined QoS policies.

In view of this there arises a need for method to allow the end users to define their preferred QoS priority.

### SUMMARY OF INVENTION

The present invention has been made in an effort to provide a method to allow allocation of bandwidth for application based on the preference of the users.

In accordance with the preferred embodiment the users are allowed to specify their preferred QoS priority by means of a Graphic Users Interface (GUI). The users defined QoS policy will then be translated into the IP (Internet Protocol)-level QoS setting that will be followed throughout the IP network.

### DESCRIPTION OF DRAWINGS

FIG. 1—GUI for user-preferred bandwidth allocation (by means of percentage)

FIG. 2—GUI for user-preferred bandwidth allocation (by means of precise bandwidth allocation)

FIG. 3—Priority labeling by agent

FIG. 4—Priority queue processing

FIG. 5—User selected configuration option

### DETAILED DESCRIPTION

The present invention provides for a method for the end users to define their preferred QoS policy. Table 1 illustrates an example of an existing QoS, where the traffic classes and their respective priority indexes can be clearly seen. An example of the users defined QoS can be seen in the shaded are of the table.

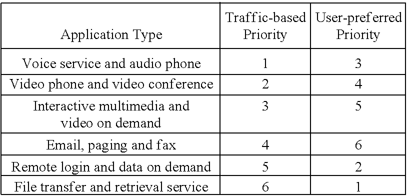

From the table it can be clearly seen how the preferred applications of the end users may vary hugely from the network provider defined application priority.

The present invention proposed to implement the users-preferred priority feature by installing a kernel-level agent (at IP stack) to manipulate the IP QoS settings according to the configuration of the users. The detailed method for such implementation will be described herein

The kernel-level agent determines the available bandwidth of the user's current network connection. In order to do this, the agent downloads one or more specific test file(s) of different size(s) from a specific server, which would be hosted by the operator or service providers that the user has subscribed for services.

The agent then proceeds to compute the time spent for downloading by deducting the start-time from the end-time of downloading each file. The file size of each downloaded file will then be divided by the time difference in order to determine the throughput or bandwidth of the current connection. When more than one file is downloaded, the average throughput or bandwidth will be determined by adding each throughput per download, then dividing it by the number of downloaded files.

Once the agent establishes the available bandwidth, it then proceeds to the next step of identifying the number of applications that have established network connections. In order to verify all network connections, including both incoming and outgoing traffic the agent accesses the Operating System service (by the command named “netstat”—Network Statistics). Specific option (i.e. -o) is used along with the “netstat” command (i.e. netstat-o) as means to discover the Process ID of each connection. Applications that connected to the network can then be identified by querying the System Task Manager based on the Process ID provided in the above step.

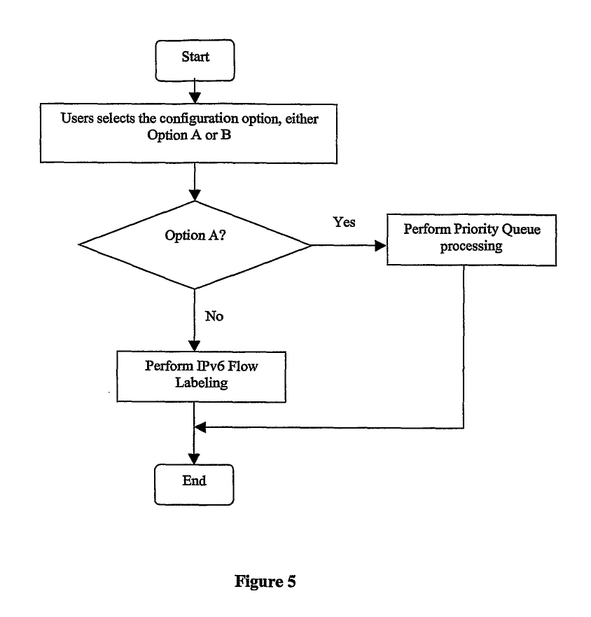

The users are then presented with a Graphic User Interface (GUI) as the means by which the users can specify their preferred bandwidth allocation. There is provided two methods to allocating the preferred bandwidth which the users can choose from. These methods are depicted as option A and option B in FIG. 5. The choice of different option will decide which QoS configuration method to be used as explained in the following sections.

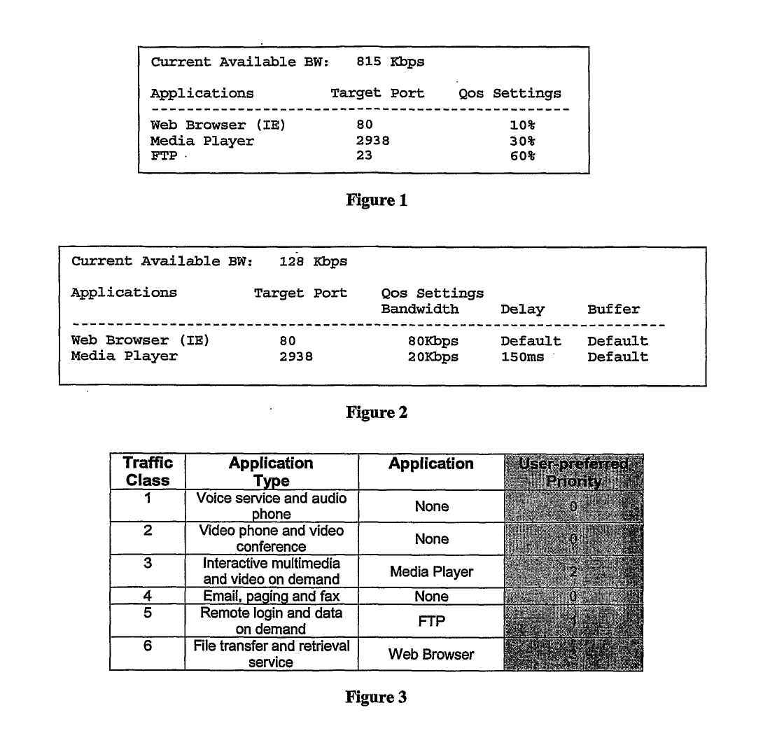

In the first method, the users can specify the preferred bandwidth for each application by percentage of the available bandwidth as shown in FIG. 1. Alternatively the users may choose to be more precise by stating down the exact bandwidth, delay and buffer value for each application as shown in FIG. 2.

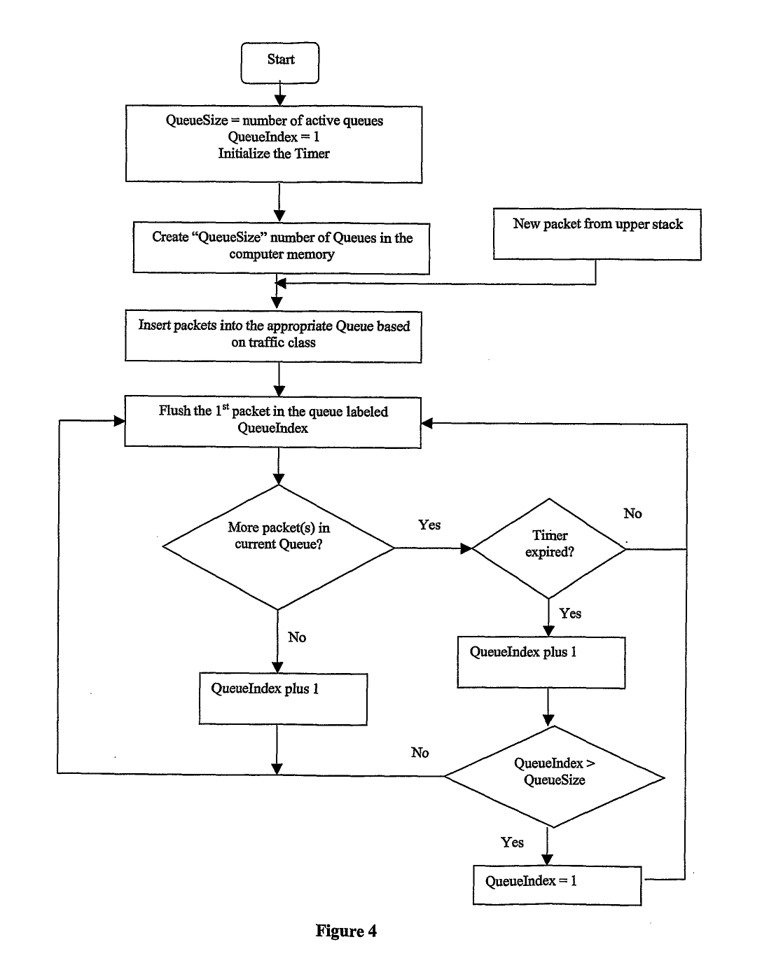

In the event that the user prefers to the first method i.e. allocating the preferred bandwidth for each application by percentage of available bandwidth, each of the application, that is currently connected to the network is classified according to the traffic table in Table 1. Therefore, when the user has configured the precedence of these applications, the agent will label a user-preferred priority index to each of them as shown in FIG. 3. This user preferred priority index is also known as the QueueIndex as shown in FIG. 4.

Following this step, a timer which is responsible for managing the priority of each application is initialized according to the ratio of the bandwidth percentage settings.

### EXAMPLE

Using the settings from FIG. 1, the timer ratio will be 6:3:1 for the application FTP, Media Player and Web Browser, where each belonged to the traffic class 5, 3 and 6 respectively (referring to FIG. 3). In the instance where a unit is 1 millisecond, it simply means the class 5 application will be given the bandwidth of 6 millisecond, class 3 application for 3 millisecond and class 6 for 1 millisecond. Similarly, in the case where the unit is 100 packets, it would then mean the class 5 application will get to send 600 packets, before the class 3 application could send its 300 packets and class 6 application to send its 100 packets.

In the second method, where the user configures using the precise bandwidth, delay and buffer value for each application the following steps for IPv6 Flow Labeling will be executed. IPv6 is used instead of IPv4 because IPv4 is less efficient on QoS management.
a. The first 3 bits (out of 20 bits) of Flow Label will be assigned a value of “001”, meaning utilizing a random number as to identify this flow.
b. The next 3 bits will be used to specify the user-preferred priority. The allocation of 3 bits here allows users to specify up to 8 priority levels.
c. The next 14 bits will be used to specify the bandwidth (5 bits, expressed in kbps), delay (5 bits, expressed in microseconds) and buffer requirements (4 bits, expressed in bytes)
   i. Example of 5-bits bandwidth specification is as follows:

| | | |
|---|---|---|
| 00000 | 32 | kbps |
| 00001 | 64 | kbps |
| 00010 | 128 | kbps |
| 00011 | 256 | kbps |
| 00100 | 512 | kbps |
| 00101 | 1 | mbps |
| 00110 | 2 | mbps |
| 00111 | 4 | mbps |

ii. Example of 5-bits delay specification is as follows:

| | | |
|---|---|---|
| 00000 | 4 | ms (micro-seconds) |
| 00001 | 8 | ms |
| 00010 | 16 | ms |
| 00011 | 32 | ms |
| 00100 | 64 | ms |
| 00101 | 128 | ms |
| 00110 | 256 | ms |
| 00111 | 512 | ms |
| 01000 | 1 | milliseconds |
| 01001 | 2 | milliseconds |

iii. Example of 4-bits buffer specification is as follows:

| | | |
|---|---|---|
| 0000 | 512 | b |
| 0001 | 1 | kb |
| 0010 | 2 | kb |
| 0011 | 4 | kb |
| 0100 | 8 | kb |
| 0101 | 16 | kb |
| 0110 | 32 | kb |
| 0111 | 64 | kb |
| 1000 | 128 | kb |
| 1001 | 256 | kb |
| 1010 | 512 | kb |
| 1011 | 1 | mb |

The well-configured packet will then be passed down to the lower stack for transmission. It is expected that the routers in the network are IPv6 capable and is able to interpret the customized flow label.

1. A method of determining the Quality of Service (QoS) in a network in which a plurality of bandwidth-occupying applications are executed, wherein a kernel-level agent is used to manipulate the IP QoS setting by the following steps:
determining the available bandwidth in the network for the execution of the plurality of network applications;
determining the number of applications connected to the network which will utilize the available network bandwidth; and
allocating the network bandwidth for the plurality of network applications according to a pre-configured bandwidth allocation value for each application.

2. A method according to claim 1, wherein end-users determine the pre-configured bandwidth value for each network application.

3. A method according to claim 2, wherein the users are allowed to specify the preferred bandwidth for each network application by means of a Graphic User Interface.

4. A method according to claim 1, wherein the kernel-level agent determines the available bandwidth according to the steps of:
downloading one or more test files of different sizes from a server;
calculating the downloading time by deducting the start-time from end-time; and
determining the throughput of the network by dividing the file size with downloading time.

5. A method according to claim 1, wherein the kernel-level agent determines the number of applications connected to the network according to the steps of:
accessing the Operating System;
determining the Process ID for each connection; and
determining the application connected to the network by using the Process ID obtained and querying the System Task Manager.

6. A method according to claim 1, wherein the users may determine the preferred bandwidth for each network application by allocating percentage of available bandwidth to each application.

7. A method according to claim 1, wherein the users may determine the precise value of bandwidth, delay and buffer value for each application.
